(19) United States
(12) Patent Application Publication
(10) Pub. No.: US 2007/0297960 A1
(43) Pub. Date: Dec. 27, 2007

(54) Extraction of Nickel and Cobalt from a Resin Eluate Stream

(76) Inventor: Damien Gary Ignatius Krebs, Kengsington (AU)

Correspondence Address: BRINKS HOFER GILSON & LIONE, P.O. BOX 10395, CHICAGO, IL, 60610, US

(21) Appl. No.: 11/761,600

(22) Filed: Jun. 12, 2007

Related U.S. Application Data
(63) Continuation of application No. PCT/AU05/01950, filed on Dec. 23, 2005.

(30) Foreign Application Priority Data
Jul. 6, 2006 (WO) 2006/069416
Dec. 30, 2004 (AU) 2004907370

(51) Int. Cl. C01G 53/04; C01G 51/00

(52) U.S. Cl. 423/140

(57) ABSTRACT

A process for the recovery of nickel and cobalt from an acidic resin eluate containing at least nickel and cobalt, said process including the steps of: (a) treating the eluate with an immiscible organic reagent (18) to selectively absorb the majority of the cobalt, and a portion of any copper, zinc and manganese present in the eluate, leaving a raffinate containing the nickel and minor impurities; (b) neutralising the raffinate to precipitate the nickel as nickel hydroxide (19); (c) stripping the cobalt from the organic reagent (22); and (d) recovering the cobalt (23).

This application is a continuation of and claims priority to PCT application PCT/AU2005/001950 filed on Dec 23, 2005 published in English on Jul. 6, 2006 as WO 2006/069416 and to Australian application no. 2004907370 filed Dec. 30, 2004, the entire contents of each are incorporated herein by reference.

### FIELD OF THE INVENTION

In general, the present invention relates to a method for producing a nickel hydroxide product and a cobalt product from an acidic resin eluate containing nickel and cobalt. The cobalt will generally be recovered as a mixed cobalt sulfide product. The present invention is particularly suited to the treatment of nickel and cobalt containing eluate that has been stripped from a resin that has been used in a resin-in-pulp process to extract the nickel and cobalt from the product slurry of a laterite acid leach process.

### BACKGROUND OF THE INVENTION

Laterite nickel and cobalt ore deposits generally contain oxidic type ores, limonites, and silicate type ores, saprolites, as two layers in the same deposits, separated by a transition zone. To minimise the equipment size for processing either the saprolites or the limonites by commercial processes, high grade limonite and saprolite are preferred.

The higher nickel content saprolites tend to be treated by a pyrometallurgical process involving roasting and electrical smelting techniques to produce ferro nickel. The power requirements and high iron to nickel ore ratio for the lower nickel content limonite, saprolite, and limonite/saprolite blends in the transition zone make this processing route too expensive.

The high nickel and cobalt content limonite is normally commercially treated hydrometallurgically by the High Pressure Acid Leach (HPAL) process, or by a combination of pyrometallurgical and hydrometallurgical processes, such as the Caron reduction roast—ammonium carbonate leach process. The HPAL process is generally less capital and energy intensive than the Caron process.

Other uncommercialised hydrometallurgical processes are described in the literature for treating nickel laterite ores with acids at atmospheric pressure, or a combination of high pressure autoclave leaching and atmospheric pressure leaching to extract the nickel and cobalt into solution.

One such process is described in U.S. Pat. No. 6,379,636 (BHP Minerals International Inc.) “Method for Leaching Nickeliferous Laterite Ores”, in which the limonite fraction of the laterite ore is subjected to a high pressure acid leach, and the high magnesium saprolite fraction is added to the autoclave discharge slurry in an atmospheric leach stage, which recovers nickel from the saprolite, in addition to partially neutralising excess acid from the pressure leach. After further partial neutralisation, iron is precipitated as jarosite.

International patent application WO/2003AU/00309, (QNI Technology Pty Ltd) “Atmospheric acid leach process for lateritic nickel ore”, describes an alternate process where the limonite fraction of the ore is leached in sulfuric acid at atmospheric pressure. The leached slurry is then mixed with high magnesium saprolite slurry in a second atmospheric pressure leach stage. After substantial completion of this step, iron is precipitated as goethite. The final leached solids are substantially free of jarosite.

A problem with an atmospheric acid leach process is that the leach slurry produced contains, in addition to the dissolved nickel and cobalt values targeted, large quantities of precipitated iron oxides and a variety of other dissolved impurities. The purification of similar nickel solutions from commercial laterite acid leach processes involve neutralisation of the acid content, solid/liquid separation followed by production of a nickel/cobalt intermediate, a re-dissolution step, and complex solvent extraction stages to produce saleable nickel and cobalt. The purification steps generally aim for complete removal of iron and the other impurities.

Ion Exchange (IX) processes, though not commercially used, have been disclosed for the extraction of both the nickel and cobalt from the nickel leachate after the neutralisation step, the iron precipitation step, and the solid/liquid separation of the leachate from the tailings via counter current decantation (CCD). The major impurities remain in the raffinate. The high iron to nickel concentration ratio in laterite ores leads to a large amount of precipitated iron and consequently demands a large CCD process.

International patent application WO/1995US/16118 (BHP Minerals International Inc.) titled “Recovery of Nickel and Cobalt from lateritic ores” describes an IX process for separating nickel from the leachate from treatment of laterite by the pressure acid leach process. Nickel is extracted by the resin at pH of around 2, and stripped with sulfuric acid for subsequent electrowinning. Cobalt remains in the raffinate along with other impurities, and after solution neutralisation is precipitated as a sulfide.

Patent WO 00/053820 (BHP Minerals International Inc.) describes the IX extraction of nickel and cobalt from acid sulfate leach solution onto the resin, and the subsequent acid stripping of the metals from the resin, and their separation by solvent extraction for the production of high purity nickel and cobalt by electrowinning.

In a further improvement to the process, U.S. Pat. No. 6,350,420 (BHP Minerals International Inc.) teaches the use of ion exchange resin in a resin in pulp process to extract nickel and cobalt onto the resin from an acid leach slurry. The leach slurry is contacted with the ion exchange resin which selectively loads nickel and cobalt from the pulp. The resin is separated from the leach slurry by screening, and stripped of the metal content with an acidic solution. The metal depleted slurry can now proceed to waste treatment and disposal and the process eliminates the requirement for the large and capitally intensive solids/liquids separation equipment normally required by the acid leach processes to extract the product solution from the solid residue.

The above documents all aim to produce relatively pure nickel solution, or nickel and cobalt strip solutions from the IX resins. The present invention aims to economically produce a nickel product with low levels of critical impurities such as copper, zinc and manganese, that is suitable for further processing, for example in the production of ferro nickel or in other hydrometallurgical nickel refinery processes. The cobalt is generally recovered as cobalt sulfide, and again, is of sufficient grade for further processing.

The above discussion of documents, articles and the like is included in the specification solely for the purpose of providing a context for the present invention. It is not suggested or represented that any or all of these matters formed part of the prior art base or were common general knowledge in the field relevant to the present invention before the priority date.

The present invention aims to provide a new process which overcomes or at least alleviates one or more of the difficulties associated with the prior art.

### SUMMARY OF THE INVENTION

In general, the present invention relates to a method for producing a nickel hydroxide product and a cobalt product from an acidic resin eluate containing nickel and cobalt. The cobalt is preferably recovered as a mixed cobalt sulfide product. In particular, the present invention is particularly suited to the treatment of nickel and cobalt containing eluate that has been stripped from a resin that has been used in a resin-in-pulp process to extract the nickel and cobalt metals from the product slurry of a laterite acid leach process.

Accordingly, in a first embodiment, the present invention resides in a process for the recovery of nickel and cobalt from an acidic resin eluate containing nickel and cobalt, including the steps of:

a. treating the eluate with an immiscible organic reagent to selectively absorb the majority of the cobalt, and a portion of any copper, zinc and manganese present in the eluate, leaving a raffinate containing the nickel and minor impurities;

b. neutralising the raffinate to precipitate the nickel as nickel hydroxide;

c. stripping the cobalt from the organic reagent; and

d. recovering the cobalt.

In general, the process forms a part of an overall process for the recovery of nickel and cobalt that utilises a resin-in-pulp circuit to extract the nickel and cobalt. The nickel hydroxide product recovered is low in critical impurities and particularly suitable for further processing, for example, in the production of ferronickel, while the cobalt will generally be recovered as an impure cobalt sulfide product.

The cobalt sulfide is generally recovered by stripping the cobalt from the organic reagent with sulfuric acid to form an acid solution, followed by precipitation of the cobalt sulfide by the addition of a sulfide to the acid solution. The sulfide is typically sodium hydrosulfide, hydrogen sulfide or a potassium hydrosulfide.

The process of the invention is particularly applicable to the recovery of nickel and cobalt from a nickel and cobalt containing acidic resin eluate wherein the eluate is the result of acid stripping an ion-exchange resin in a resin-in-pulp circuit in a nickel and cobalt recovery process. The resin is generally stripped by treating the resin with concentrated acid, preferably sulfuric or hydrochloric acid, to produce the acidic eluate.

Preferably, the ion exchange resin is a resin having an iminodiactic functional group which loads nickel, cobalt, and any copper, zinc, aluminum, ferrous iron and chromium present almost completely together with quantities of manganese and a small amount of magnesium in a resin-in-pulp process. Alternatively, a resin having a bis-picolylamine functionality such as Dowex 4195, may be used.

Preferably, the nickel and cobalt recovery process is an atmospheric pressure acid leach of a nickel containing laterite ore, but may also be a high pressure acid leach or a combination of high pressure acid leach and atmospheric pressure acid leach of laterite ores. In another embodiment, the eluate may be produced by the acid treatment of the resin in a resin-in-pulp treatment of the product slurry from an oxidative leach of a nickel sulfide ore or concentrate, or the product slurry from the acid leach of a combination of laterite and sulfide ores.

In another embodiment, the eluate may be from resin treatment of product liquor solutions containing at least nickel and cobalt, and obtained from acid leaching of lateritic or sulfide ores after separation of the leach residues from the solutions.

In a process where laterite ore is treated in an acid leach process, the laterite ore may be processed by first separating the laterite ore into its low magnesium containing limonite fraction, and its high magnesium containing saprolite fraction and sequentially leaching the limonite and saprolite fractions. The limonite fraction may be treated with acid in a primary leach step to produce a primary leach slurry. The saprolite fraction may then be added to the primary leach slurry which will initiate precipitation of iron as goethite and produce a secondary leach slurry containing at least nickel and cobalt ions. This will also result in higher amounts of acid available for the leach process as acid will be produced upon precipitation of the iron.

The resultant secondary leach slurry then reports to a resin-in-pulp circuit where at least the nickel and cobalt ions are loaded on to the resin. Accordingly, where laterite ore is treated under acid leach conditions, the process preferably includes the additional steps of:

a. separating the laterite ore into its low magnesium limonite fraction and high magnesium saprolite fraction;

b. treating the limonite fraction with acid in a primary leach stage to produce a primary leach slurry; and

c. adding the saprolite fraction to the primary leach slurry in a secondary leach step to initiate precipitation of iron as goethite resulting in higher levels of acid available in the secondary leach step, and to produce a secondary leach slurry containing nickel and cobalt ions;

wherein the secondary leach slurry reports to a resin-in-pulp circuit wherein at least the nickel and cobalt are loaded on to the resin.

Preferably the pH of the secondary leach slurry is partially neutralised to a pH of around 2 to substantially complete precipitation of iron as goethite. The secondary leach slurry is then neutralised further to raise and maintain the pH to at least 4, most preferably between 4 and 5, to precipitate or depress ferric ions and other impurities that may be present, prior to or simultaneously with reporting to the resin-in-pulp circuit.

In the resin-in-pulp circuit, the resin will absorb at least the nickel, cobalt and some other minor impurities from the secondary leach slurry. The resin may be eluted with weak sulfuric acid initially, to remove substantially all or any magnesium, calcium and manganese prior to stripping the resin with the strong sulfuric acid. The resin may also be washed with a good quality water prior to stripping the nickel and cobalt from the resin.

The loaded resin is then treated with a strong acid to strip off the metals from the resin to produce a nickel and cobalt containing acidic eluate. The acid is most preferably a strong sulfuric acid, although hydrochloric acid may also be used.

The acid resin eluate containing the nickel and cobalt preferably is then neutralised with a neutralising agent to a pH of about 4.5 to 5 prior to separation of the nickel and cobalt. Most preferably, the neutralising agent is sodium hydroxide, sodium carbonate, magnesium carbonate or calcium carbonate. The eluate itself contains from about 10 to 80 g/L nickel following elution from the resin.

The immiscible organic reagent that is used to selectively absorb the majority of the cobalt and a portion of any copper, zinc and manganese present is preferably Cyanex 272. Cyanex 272 is selective for cobalt over nickel and as such, will separate the nickel and cobalt in the acidic resin eluate. Sulfuric acid is then used to strip the cobalt from the immiscible organic reagent to produce a cobalt containing sulfuric acid solution. A sulfide product is then added to the sulfuric acid solution to precipitate the cobalt as an impure cobalt sulfide. Preferably, the sulfide product is either a sodium hydrosulfide, hydrogen sulfide or a potassium hydrosulfide, but any suitable sulfide product will do, so long as it precipitates the cobalt as a cobalt sulfide product.

In order to precipitate the nickel as nickel hydroxide, the pH of the raffinate is first raised to a pH of greater than 7.5 by addition of a neutralising agent, preferably a magnesium oxide slurry, to precipitate the nickel as nickel hydroxide. The nickel hydroxide is then filtered and washed for recovery of the nickel product. The nickel hydroxide product produced is low in critical impurities such as copper, zinc and manganese and may be useful for use in further nickel processes.

The process of the present invention has particular benefits in the recovery of nickel and cobalt from an acidic eluate stream in that the nickel and cobalt is recovered in a form which is readily transportable and has ready uses for further processing.

In combination with an atmospheric pressure leach process of laterite ores and a resin-in-pulp circuit, the process is particularly beneficial in that impurities may be readily removed, particularly residual ferric ions which are precipitated as goethite during the leach process, leading to recovery of a nickel and cobalt product, that is in a form suitable for use in further refinery processes. The removal of such impurities in a resin-in-pulp circuit can obviate the need to employ sizable settler tanks used to remove large quantities of iron impurities, saving considerably in capital expenditure.

### BRIEF DESCRIPTION OF THE DRAWINGS

FIG. 1 illustrates a preferred flow-sheet of a process for the recovery of nickel as a nickel hydroxide, and cobalt as a mixed cobalt sulfide in accordance with a process of the invention.

### DETAILED DESCRIPTION OF THE EMBODIMENTS

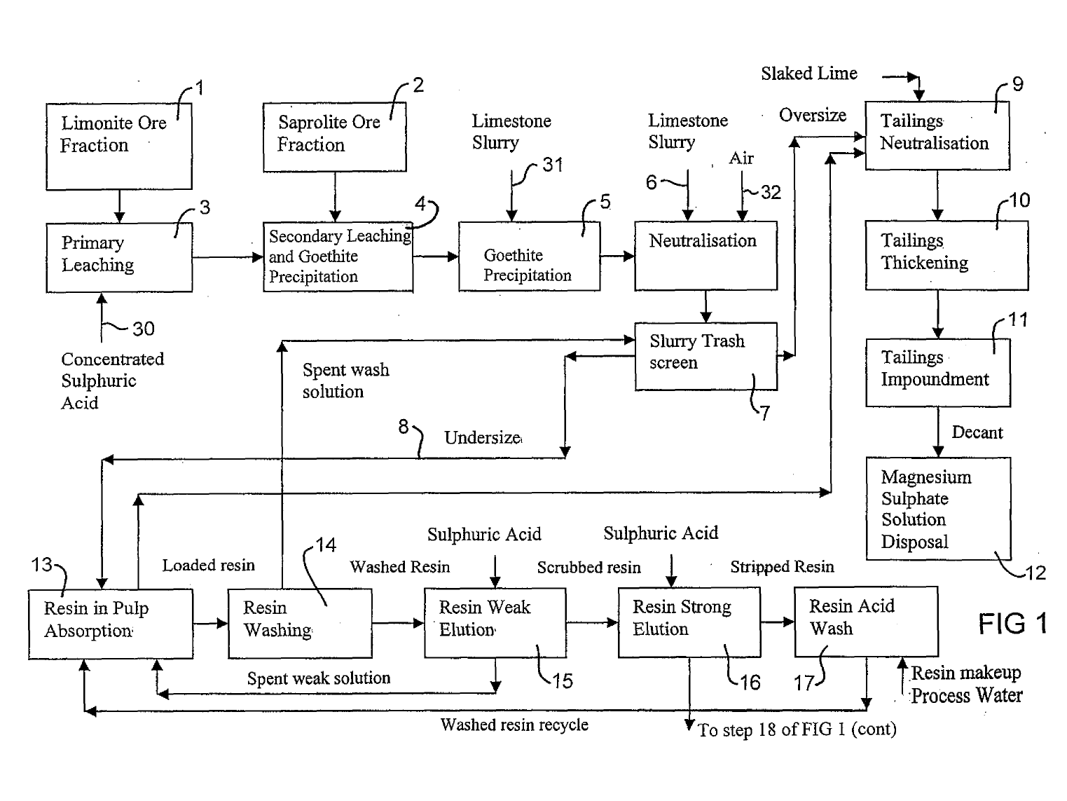

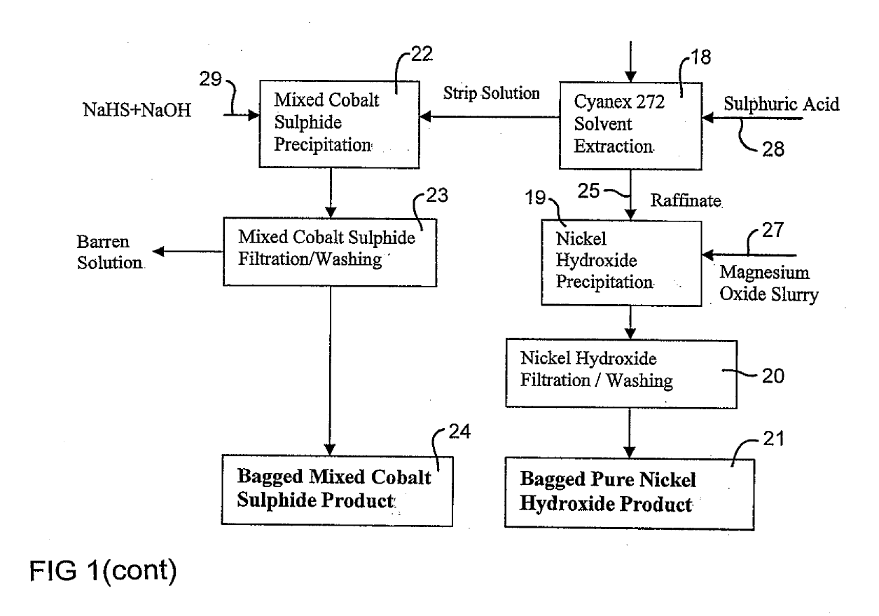

In the preferred process, lateritic ore is processed and it is convenient to describe the process with reference to the processing of a nickel containing laterite ore, as indicated in FIG. 1. It should be understood that FIG. 1 is illustrative of preferred embodiments of the invention and for convenience the preferred embodiments of the invention have been described with reference to FIG. 1. The invention should not, however, be considered to be limited to the features described in FIG. 1.

The nickel containing laterite ore is preferably separated into a low magnesium containing ore fraction (1) and high magnesium ore fraction (2) by selective mining or post mining classification. The limonite (low magnesium) fraction of a nickel laterite ore (1) is treated with concentrated sulfuric acid (30) in a primary leach stage (3) at atmospheric pressure. The saprolite (high magnesium fraction) of the ore (2) is added to the product slurry from the primary leach in a secondary leach step (4) with iron precipitated as goethite.

The iron which goes into solution is further precipitated as goethite (5), that is FeO(OH), following the addition of a limestone slurry (31). This results in a higher amount of acid being available for the second leach step than if the iron was precipitated as, for example, jarosite.

The primary leaching (3) is carried out at a temperature up to 105° C., most preferably as high as possible to achieve rapid leaching at atmospheric pressure. The dose of sulfuric acid is preferably 100 to 140% of the stoichiometric amount to dissolve approximately over 90% of nickel, cobalt, iron, magnesium, aluminium and manganese in the ore.

In order to liberate the cobalt content of asbolane, or other similar Mn (III or IV) minerals, a reductant, for example, a sulfur dioxide gas or sodium-free metabisulfite or sulfite, is preferably injected into the product slurry from the primary leach to control the redox potential to preferably less than 1000 mV (SHE), and most preferably about 900 mV (SHE). The completion of reduction and leaching is indicated by the formation of 0.5 to 1.0 g/L ferrous ion (Fe²⁺) and steady acid concentration under these reaction conditions. The weight loss of the low magnesium limonite ore is typically over 80% and the extraction of nickel and cobalt is over 90%.

The secondary leach step (4) which is preferably carried out at atmospheric pressure, includes the simultaneous leaching of saprolite and iron precipitation, preferably as goethite or other relatively low sulfate-containing forms of iron oxide or iron hydroxide. No additional acid is added during the second leach step.

The secondary leach step (4) is carried out at the temperature, preferably up to 105° C., and most preferably as high as possible to achieve rapid leaching and iron precipitation kinetics, at atmospheric pressure. The dose of high-Mg saprolite ore added to the primary leach slurry is determined by the free acid remaining from the first leach step, the acid released during iron precipitation as goethite and the unit stoichiometric acid-consumption of high-Mg saprolite ore at given extractions of nickel, cobalt, iron, magnesium, aluminum and manganese in the ore.

With the introduction of the saprolite ore, iron precipitation as goethite will generally occur. The saprolite ore generally contains some iron as goethite together with other fine particles that function as seeds, which can initiate goethite precipitation. However, immediately after the introduction of the saprolite, “seeds” that predominantly contain goethite or jarrosite, may be added to the reactor should this be required, as the addition of seeds may assist in the leaching of saprolite ore and the iron precipitation as goethite, or other relatively low sulfate-containing forms of iron oxide or iron hydroxide, to occur simultaneously.

The secondary pregnant leach slurry containing the nickel and cobalt, is then neutralised with limestone slurry at 80° C. to force iron precipitation as goethite substantially to completion (5). The end point of goethite precipitation is around pH 2.0.

The pregnant slurry is further neutralised to at least pH 4 with additional limestone slurry (6), and aerated (32), precipitating the residual ferric ions and other impurities, such as copper, aluminum, chromium, and additional iron, particularly ferric iron. The slurry then passes through a trash screen (7) and reports to the resin-in-pulp circuit. The oversize material from the trash screen passes to the tailings disposal section (9). A neutralizer such as limestone or lime is added during the resin-in-pulp circuit to maintain the pH at around 4. The tailings are neutralised with slaked lime, and then thickened (10), undergo tailings impoundment (11) and then decanted for disposal (12).

The pregnant slurry (8) is then treated by the resin in pulp process where the nickel and cobalt and some impurities are extracted by the resin. The resin-in-pulp process consists of contacting the resin counter-currently with the leach slurry, typically in a series of air agitated or mechanically agitated continuously stirred tank reactors (13). In each of these stages the resin is separated from the slurry by screening and is advanced by pumping to the next stage. The slurry itself is advanced from one tank to the next, typically by gravity. Typically, an ion exchange resin with an iminodiacetic functional group is used in the resin-in-pulp process, for example iminodiacetic acid Amberlite IRC 718 or 748. This loads nickel, cobalt, copper, zinc, aluminum, ferrous iron and chromium almost completely, about half of the manganese and a small amount of magnesium. Other suitable resins with different functional groups may be chosen if they extract the appropriate elements from the solution, for example Dowex 4195. Limestone slurry is added for controlling pH to between 4 and 5 during the resin loading stages.

Thorough washing of the final resin is required (14) to ensure that all entrained solids are removed from the resin prior to stripping. Resin is washed with good quality water before passing to a weak sulfuric acid elution step (15). This step uses dilute acid to remove almost all of the magnesium, calcium, and some manganese from the resin prior to stripping. The weak acid elution liquor passes back to the washing stage as wash water.

Concentrated sulfuric acid strip solution (16) is used to strip the metal values from the resin, producing an eluate containing from 10 to 80 gpl nickel as well as cobalt. The resin is subjected to a weak acid wash (17) after stripping in order to minimize nickel recycle, and is transported back to the resin-in-pulp reactors.

The strong nickel and cobalt containing acidic elutate is preferably partially neutralised to around pH 5 with sodium hydroxide to prepare it for the separation of cobalt from nickel.

The cobalt is separated from the nickel in the eluate by contacting the eluate with an immiscible organic solvent, preferably containing the extractant Cyanex 272, in a solvent extraction step (18). Cyanex 272 is selective for cobalt over nickel, and after separation of the extractant, which also removes any remaining zinc, copper and manganese, a nickel containing raffinate remains.

The raffinate (25) is neutralised with magnesium oxide slurry (27), to a pH of greater than 7.5, precipitating the nickel as nickel hydroxide (19), which can be filtered and washed (20) for direct sale. The nickel hydroxide produced contains approximately 40% nickel and low levels of iron (21).

It is a suitable direct feed for the production of Ferro Nickel in electric arc furnaces, or for feeding to other hydrometallurgical nickel refinery processes.

The cobalt containing organic extractant from the solvent extraction stage (18), is preferably stripped with dilute sulfuric acid (28), to produce a strip solution containing the cobalt, but also the nickel, zinc, iron, manganese and copper that were extracted with it. In a preferred embodiment of the invention, the cobalt is precipitated as a mixed cobalt sulfide (22) by treating the strip solution with sodium hydrogen sulfide solution together with sodium hydroxide (29). The temperature is maintained between 60 and 80° C. to ensure that the sulfide product obtained is crystalline. The impure cobalt sulfide solid is then filtered washed (23), and dried for direct sale (24).

In other embodiments of the invention, the cobalt may be recovered by known techniques such as solvent extraction or electro winning.

The new process has the advantage over the current hydrometallurgical routes, in that it has fewer complex and capital intensive process steps to convert ore to a finished metal product, ferro nickel. The steps of solid liquid separation before solution treatment, solvent extraction to eliminate impurities, and the purified nickel metal production steps, such as electro winning or hydrogen reduction, are not necessary.

It has a major advantage over the conventional saprolite smelting processes to produce ferro nickel, in that the quantity of mixed hydroxide product material to be smelted is approximately one fiftieth of the equivalent quantity of saprolite ore that would be required, with major associated power savings.

A further advantage of the process over the conventional ferro nickel smelting process is that the valuable metal cobalt is recovered separately for sale, whereas in saprolite smelting the cobalt becomes part of the ferro nickel and its value is lost to the producer.

A further advantage of the process described is that, as a consequence of the resin elution and solvent extraction process steps, the impurity levels in the ferro nickel produced using this nickel hydroxide product will be significantly lower than those currently achieved by the majority of commercial producers, and even those in the “super pure” ferro nickel grade.

The process is also particularly attractive where large low grade deposits of saprolite or limonite exist at an established saprolite mining and smelting operation producing ferro nickel from the high grade ore. This process would allow treatment of the low grade ores which would normally be rejected to produce a mixed hydroxide feed for the existing smelter, reducing the unit power consumption per ton of nickel produced, producing cobalt for sale, and significantly improving the overall economics of the mining and processing the whole ore body.

The process also has the flexibility that low iron nickel hydroxide product suitable for feeding to a ferro nickel smelter can be produced by this process in plant located at the laterite ore body, and shipped cost effectively because of its high nickel content to a remote existing ferro nickel smelter if the economics favour this.

### EXAMPLES

### Example 1

A sample of slurry from the High Pressure Acid leach (HPAL) of a lateritic nickel ore was neutralised and screened in order to be treated by a resin-in-pulp (RIP) treatment process.

15 L of HPAL pulp slurry was placed in a 20-litre drum and stirred with an overhead stirrer. The pulp slurry was adjusted to pH 4.5 by adding limestone slurry. After neutralisation, the ORP of the pulp was adjusted to 300-400 mV. by the addition of a 20% sodium metabisulfite solution.

The pulp was then screened to 212 microns, and oversize material discharged. Pulp passed through 212-micron screen was collected and used in the RIP circuit. The screened and neutralised pulp was brought to a temperature of 50° C. and continuously added into a ten stage RIP pilot plant to contact a Clean TeQ R604 resin. R604 is an ion exchange resin containing iminodiacetic acid groups. The nickel cobalt and other metals were adsorbed onto the resin. The resin was then separated from the pulp, and the metals stripped from it by treatment with a 15% sulfuric acid solution.

Table 1 below shows the average metal content of the liquor and solids content of the ore pulp slurry before and after RIP treatment during the 50 hour test run. Extraction rates were greater than 99.7% for both nickel and cobalt from the liquid phase of the pulp, and there was significant recovery of nickel and cobalt from the solid phase also.

TABLE 1
Average metal content of pulp liquor
and solids before and after Resin in Pulp treatment.

| | Ni | Co | Fe | Mn | Mg | Cu | Zn | Al | Ca | Si | Cr | Na |
|---|---|---|---|---|---|---|---|---|---|---|---|---|
| Stream Analysis | mg/L | mg/L | mg/L | mg/L | mg/L | mg/L | Mg/L | mg/L | mg/L | mg/L | mg/L | mg/L |
| Feed Pulp liquid | 5342 | 138 | 0.49 | 1316 | 13164 | 0.45 | 19 | 0.32 | 586 | 48 | 0.15 | 9976 |
| Discharge pulp | 9.65 | 0.8 | 0.3 | 214 | 6726 | 0.1 | 0.27 | 0.5 | 557 | 43 | <0.2 | 8057 |
| liquid | | | | | | | | | | | | |
| Feed Pulp solids | 2108 | 61 | 21 | 540 | 0.2 | 76 | 71 | 1.4 | 3 | 0.89 | 20.6 | 9123 |
| Discharge pulp | 1275 | 46 | 20 | 534 | 0.17 | 54 | 54 | 1.4 | 3.6 | 0.9 | 20 | 8161 |
| solids | | | | | | | | | | | | |

The composition of the eluate from the resin acid strip is indicated in table 2 below. This indicates that nickel concentrations of around 39 gpl in the eluate can be achieved, with low levels of contaminants such as chromium and silica.

TABLE 2
Metal content of the Eluate after resin stripping.

| | | Ni | Co | Fe | Mn | Mg | Cu | Zn | Al | Ca | Si | Cr | Na |
|---|---|---|---|---|---|---|---|---|---|---|---|---|---|
| Type | Description | mg/L | mg/L | mg/L | mg/L | mg/L | mg/L | mg/L | mg/L | mg/L | mg/L | mg/L | mg/L |
| Sample 1 | Desorption | 33700 | 892 | 22.4 | 5600 | 4470 | 11.9 | 155 | 1 | 791 | 8 | <0.2 | 348 |
| | Eluate | | | | | | | | | | | | |
| Sample 2 | Desorption | 39400 | 858 | 7.6 | 5000 | 4780 | 9.1 | 151 | 1 | 917 | 8 | <0.2 | 324 |
| | Eluate | | | | | | | | | | | | |
| Sample 3 | Desorption | 36100 | 603 | 50 | 2660 | 3250 | 41.5 | 154 | 2.5 | 764 | 8 | <0.2 | 320 |
| | Eluate | | | | | | | | | | | | |
| Sample 4 | Desorption | 32800 | 612 | 29.6 | 2380 | 2060 | 55.7 | 143 | 0.5 | 649 | 9 | 0.2 | 220 |
| | Eluate | | | | | | | | | | | | |

### Example 2

A synthetic solution that would simulate the eluate produced from the atmospheric pressure leaching of a laterite ore was prepared for testing. The solution was prepared by dissolving the sulfates of nickel, cobalt, copper, manganese, iron, and magnesium, together with calcium hydroxide and sodium chloride in water, and maintaining the solution under a nitrogen atmosphere to prevent oxidation. It was then subjected to neutralisation by adjusting the pH to 4.5 by the addition of calcium carbonate, allowed to settle and the clear solution decanted to become the feed solution for the tests. The solution analysis before and after the neutralisation step are shown in Table 3.

TABLE 3

| | Concentration (ppm) | | | | | | | | | | |
|---|---|---|---|---|---|---|---|---|---|---|---|
| Solution | pH | Fe(II) | Cu | Zn | Co | Ni | Mn | Mg | Ca | Na | Cl |
| Prepared solution | 2.3 | 583 | 290 | 232 | 3,226 | 35,295 | 3181 | 566 | 491 | 15.9 | <5 |
| Feed solution(after | 4.5 | 553 | 265 | 241 | 3,251 | 35,221 | 3133 | 574 | 637 | 15.7 | — |
| neutralization) | | | | | | | | | | | |

A solvent extraction pilot plant consisting of 10 water-jacketed mixer-settlers, was used to conduct counter current semi continuous extraction, scrubbing and stripping tests on the Feed solution after neutralisation. The organic solution used as the solvent contained 15% Cyanex 272(v/v) and 5%TPB in Shellsol D70. The volume of the mixer and settler was 0.16 L and 0.38 L respectively. The temperature of the solution was kept constant at 40° C. Impellers (30 mm diameter) with six-vanes were used for solution mixing and diaphragm pumps were used for solution circulation.

During semi continuous extraction operation, aqueous solution and blank organic solutions were pumped counter-currently through three extraction stage mixer/settlers. Sodium hydroxide solution or sulfuric acid were used to maintain a pH of 5.8 in the mixers. Aqueous recycling was arranged to obtain an A/O volume ratio of 1:1 in the mixer when required. Nitrogen gas was bubbled in the first stage mixer to prevent the oxidation of Fe(II) to Fe(III).

Table 4 shows the extent of extraction of the metals in the organic solvent. The test shows that a complete extraction of Co, Cu, Zn, Mn, and Fe was achieved.

TABLE 4

| Metal | | In Loaded | | |
|---|---|---|---|---|
| Concentration (g/L) | In Feed | organic | In Raffinate | Extraction (%) |
| Ni | 35.26 | 0.332 | 26.54 | 1.23 |
| Co | 3.140 | 3.020 | 0.000 | 100.00 |
| Cu | 0.283 | 0.301 | 0.000 | 100.00 |
| Zn | 0.238 | 0.225 | 0.000 | 100.00 |
| Mn | 2.996 | 2.833 | 0.000 | 100.00 |
| Mg | 0.544 | 0.234 | 0.167 | 58.39 |
| Ca | 0.615 | 0.019 | 0.433 | 4.27 |
| Fe | 0.467 | 0.462 | 0.000 | 100.00 |

### Example 3

The objective of the semi continuous scrubbing test was to maximise the scrubbing of the loaded organic solution to remove the co-extracted Ni, Mg and Ca.

The loaded organic solution from a series of semi continuous extraction tests similar to Example 1 was combined and used for the semi continuous scrubbing tests. The parameters varied were controlled pH (5.4 and 5.6 by the addition of sulfuric acid), number of stages (1 and 2 stages) and scrub solution (solutions 1 and 2) and a temperature of 40° C.

A synthetic scrub solution was prepared to simulate a diluted solution from the strip liquor. A typical result from the semi continuous scrubbing is summarised in Tables 5. The Ni scrub efficiency was in the range of 90-93% with 38-53 ppm Ni left in the organic solution.

The higher concentration of Co, Cu, Mn and Zn in the scrub solution did not affect the scrubbing efficiency and one stage of scrubbing gave much lower Ni scrub efficiency (77.8%) and higher Ni concentration in the scrubbed organic solution (118 ppm).

TABLE 5
Results of semi continuous scrubbing Test

| Metal | In Loaded | In scrub | In scrubbed | Scrub |
|---|---|---|---|---|
| Concentration (g/L) | organic | solution | organic | Efficiency (%) |
| Ni | 0.530 | 0.003 | 0.038 | 92.90 |
| Co | 2.525 | 2.687 | 2.806 | −11.12 |
| Cu | 0.248 | 0.273 | 0.273 | −10.06 |
| Zn | 0.215 | 0.181 | 0.233 | −8.56 |
| Mn | 2.379 | 2.599 | 2.772 | −16.56 |
| Mg | 0.280 | 0.021 | 0.160 | 42.95 |
| Ca | 0.070 | 0.027 | 0.005 | 93.27 |
| Fe | 0.440 | 0.002 | 0.388 | 11.80 |

### Example 4

The organic solutions from the semi continuous scrubbing tests in Example 2 were combined and used in the semi continuous three stage stripping test to recover the cobalt values.

During semi continuous stripping operation, the pre-loaded and scrubbed organic solution was stripped using a sulfuric acid solution with the pH in the last stage controlled at 2.0.

The results of the stripping test are summarised in Table 6. At pH 2.0 with three stages, some 99% of Co, Cu, Mn and Zn and 78% Fe were stripped.

TABLE 6
Results of semi continuous stripping (pH 2.00, 3 stage)

| Metal | In scrubbed | In stripped | In Strip | Strip |
|---|---|---|---|---|
| Concentration (g/L) | organic | organic | liquor | Efficiency (%) |
| Co | 3.037 | 0.009 | 15.949 | 99.70 |
| Cu | 0.350 | 0.003 | 1.574 | 99.23 |
| Zn | 0.255 | 0.003 | 1.014 | 98.82 |
| Mn | 3.059 | 0.005 | 16.456 | 99.85 |
| Fe | 0.381 | 0.081 | 0.850 | 78.83 |

### Example 5

The raffinate solutions from the semi continuous extraction tests in Example 1 were combined and subjected to hydroxide precipitation. The objective of the batch nickel hydroxide precipitation tests was to determine test conditions for a nickel precipitation efficiency of >99%. A total of three tests were conducted with the mole ratio of MgO over Ni to be 1:1, 1.2:1 and 1.4:1.

The purity of MgO used in the precipitation tests was 96%.

Weighed MgO powder was added slowly and the slurry was mixed for one hour before vacuum filtration. The filtrate was collected in the vacuum flask, weighed and its mass recorded. The cake was re-slurried with 100 mL of tap water and the slurry vacuum filtered. Three washes were performed for each filter cake and the three washing solutions were combined. The washed filter cake was dried at 105° C. and weighed at room temperature.

The Ni precipitation efficiency reached over 99.9% for the three tests conducted, indicating a very low Ni loss and high Ni recovery (Table 7 below). While the Ni recovery in the three tests was almost the same, the Mg content in the Ni product cake increased with the increasing mole ratio from 3.36% for mole ratio 1:1 to 7.14% for 1.2:1 and further to 9.55% for 1.4:1. This means the mole ratio of 1:1 performed the best among the three tests conducted.

TABLE 7
Ni hydroxide precipitation test results

| | | | Ni in | | | | |
|---|---|---|---|---|---|---|---|
| | Mole | | feed | Ni in | Ni in | Ni in | Ni |
| Test | Ratio | | solution | cake | filtrate | wash | recovery |
| No | MgO/Ni | pH | (g/L) | % | (g/L) | (g/L) | (%) |
| 1 | 1.0:1 | 9.4 | 25.72 | 44.55 | 0.0088 | 0.0005 | 99.96 |
| 2 | 1.2:1 | 9.7 | 25.72 | 38.55 | 0.0042 | 0.0017 | 99.96 |
| 3 | 1.4:1 | 3.7 | 25.72 | 35.83 | 0.0037 | 0.0004 | 99.98 |

The elemental analysis of the nickel hydroxide precipitate produced indicates very low levels of impurities, cobalt, copper, zinc, manganese and iron, as seen in Table 8 below.

TABLE 8
Elemental analyses in the product Ni hydroxide precipitate*

| MgO/Ni | Concentration (mg/L) | | | | | | | |
|---|---|---|---|---|---|---|---|---|
| ratio | Ni | Co | Cu | Zn | Mn | Mg | Fe | Ca |
| 1.2 | 3265 | 0.295 | <0.20 | <0.20 | <0.20 | 605 | <0.20 | 0.694 |

*The precipitate sample was dissolved in acid solution for assay.

### Example 6

The solvent extraction strip liquor from the semi continuous organic strip tests in example 3 were combined and subjected to mixed sulfide precipitation using sodium hydrosulfide solution to recover the cobalt content. The pH was adjusted to 3.5 with sodium hydroxide solution or sulfuric solution and the temperature controlled at 80° C. After 60 minutes of mixing the slurry was filtered, the cake reslurried with tap water and refiltered three times, before drying at 105° C.

The cobalt precipitation efficiency under these conditions was very high at 99.82%.

Table 9 below indicates the precipitation efficiency of the other metals in the solvent extraction strip liquor.

TABLE 9
Metal behaviour in mixed sulfide precipitation (Mole ratio 1.4:1)

| | In feed | In | In filtrate | In wash | Precipitation efficiency |
|---|---|---|---|---|---|
| Metal | (g/L) | cake (%) | (g/L) | (g/L) | (%) |
| Co | 14.94 | 40.81 | 0.0100 | 0.0073 | 99.82 |
| Ni | 1.60 | 4.52 | 0.0007 | 0.0004 | 99.89 |
| Cu | 1.37 | 3.93 | 0.0000 | 0.0000 | 100.00 |
| Zn | 0.63 | 1.69 | 0.0000 | 0.0000 | 100.00 |
| Mn | 15.59 | 1.17 | 13.8925 | 0.4731 | 2.72 |
| Fe | 0.37 | 0.92 | 0.0341 | 0.0045 | 88.07 |

The above description is intended to be illustrative of the preferred embodiment of the present invention. It should be understood by those skilled in the art, that many variations or alterations may be made without departing from the spirit of the invention as outlined herein.

1. A process for the recovery of nickel and cobalt from an acidic resin eluate containing at least nickel and cobalt, said process including the steps of:
a. treating the eluate with an immiscible organic reagent to selectively absorb the majority of the cobalt, and a portion of any copper, zinc and manganese present in the eluate, leaving a raffinate containing the nickel and minor impurities;
b. neutralising the raffinate to precipitate the nickel as nickel hydroxide;
c. stripping the cobalt from the organic reagent; and
d. recovering the cobalt.

2. A process according to claim 1 wherein the acidic resin eluate is an eluate that has been stripped from ion exchange resin loaded with at least nickel and cobalt in a resin-in-pulp circuit in a nickel and cobalt recovery process.

3. A process according to claim 2 wherein the ion exchange resin has iminodiacetic functional groups or bis-picolylamine functional groups.

4. A process according to claim 3 wherein the ion exchange resin has iminodiacetic functional groups.

5. A process according to claim 2 wherein the nickel and cobalt is recovered in an atmospheric pressure or high pressure acid leach process of a laterite ore, or an oxidative leach of a nickel sulfide ore or concentrate.

6. A process according to claim 2 wherein the nickel and cobalt is recovered from the product slurry from the acid leach of a combination of laterite and sulfide ores.

7. A process according to claim 5 wherein the nickel and cobalt are recovered by atmospheric pressure acid leaching of laterite ore.

8. A process according to 7 wherein the laterite ore is processed according to the following steps:
a. separating the laterite ore into its low magnesium limonite fraction and high magnesium saprolite fraction;
b. treating the limonite fraction with acid in a primary leach stage to produce a primary leach slurry; and
c. adding the saprolite fraction to the primary leach slurry in a secondary leach step to initiate precipitation of iron as goethite resulting in higher levels of acid available in the secondary leach step, and to produce a secondary leach slurry containing nickel and cobalt ions;
wherein the secondary leach slurry reports to a resin-in-pulp circuit wherein at least the nickel and cobalt are loaded on to the resin.

9. A process according to claim 8 wherein the pH of the secondary leach slurry is partially neutralised to a pH of around 2 to substantially complete precipitation of iron as goethite, and then raised further to a pH of around 4 to precipitate ferric ions and other impurities, prior to reporting to the resin-in-pulp circuit.

10. A process according to claim 9 wherein the resin in the resin-in-pulp circuit loads at least nickel, cobalt, and a portion of any copper, zinc, aluminum, ferrous iron and chromium present in the secondary leach slurry.

11. A process according to claim 10 wherein the resin is eluted with weak sulfuric acid to remove substantially all of any magnesium, calcium and manganese prior to stripping the resin.

12. A process according to claim 8 wherein the resin in the resin-in-pulp circuit is treated with a concentrated acid to strip off the loaded metals to produce the acidic resin eluate containing at least nickel and cobalt.

13. A process according to claim 12 wherein the concentrated acid used to strip the resin is sulfuric acid or hydrochloric acid.

14. A process according to claim 12 wherein the acid resin eluate containing the nickel and cobalt is partially neutralised with a neutralizing agent to a pH of about 4.5 to 5 prior to separation of the nickel and cobalt.

15. A process according to claim 14 wherein the neutralising agent is sodium hydroxide, sodium carbonate, magnesium carbonate or calcium carbonate.

16. A process according to claim 15 wherein the eluate contains from 10 to 80 g/L nickel.

17. A process according to claim 1 wherein the immiscible organic reagent used to selectively absorb the majority of the cobalt and any copper, zinc and manganese present is Cyanex 272.

18. A process according to claim 1 wherein sulfuric acid is used to strip cobalt from the immiscible organic reagent and to produce a cobalt containing sulfuric acid solution.

19. A process according to claim 18 wherein a sulfide is added to the sulfuric acid solution to precipitate the cobalt as impure cobalt sulfide.

20. A process according to claim 19 wherein the sulfide is sodium hydrosulfide, hydrogen sulfide or a potassium hydrosulfide.

21. A process according to claim 1 wherein the raffinate is neutralised with magnesium oxide slurry to precipitate the nickel as nickel hydroxide.

22. A process according to claim 21 wherein the pH of the raffinate is raised to a pH of greater than 7.5 to enable precipitation and recovery of the nickel as nickel hydroxide.
